(19) United States
(12) Patent Application Publication
(10) Pub. No.: US 2022/0050703 A1
(43) Pub. Date: Feb. 17, 2022

(54) AUTONOMOUS COMPUTER SYSTEM DEPLOYMENT TO A VIRTUALIZED ENVIRONMENT

(71) Applicant: Peter B. Woodhull, North Charleston, SC (US)

(72) Inventor: Peter B. Woodhull, North Charleston, SC (US)

(21) Appl. No.: 17/197,755

(22) Filed: Mar. 10, 2021

Related U.S. Application Data
(60) Provisional application No. 63/064,982, filed on Aug. 13, 2020.

(51) Int. Cl. G06F 9/455; G06F 8/60

(52) U.S. Cl. CPC G06F 9/45558; G06F 2009/45595; G06F 2009/4557; G06F 8/60

(57) ABSTRACT

The invention improves the use of computers as a tool by autonomously creating virtual computing systems in virtualized or cloud environments. An apparatus or product for autonomously deploying a computer system to a virtual environment, and a method using same that includes modeling a computer system in a modeling language to generate a design model. Processes may also include parsing the design model to generate a set of scripts comprising the virtual system components. The virtual system components may be deployed by executing the scripts. The system may validate that the deployed virtual system components are compliant with the design model. The system may be designed in a modeling language such as Systems Modeling Language (SysML) or Unified Modeling Language (UML). Processes may modify system settings to configure, secure, and harden the system components.

Applicant claims priority to U.S. Provisional Patent Application Ser. No. 63/064,982 dated Aug. 13, 2020.

### BACKGROUND OF THE INVENTION

Computer systems and applications are generally designed in modeling software that enables a system architect to draw multiple aspects of an end solution. The design drawing, referred to as a design model, typically includes components such as networks, servers, and applications. The design model may additionally include behaviors such as control and message flow. Common design notations or languages may be utilized to enable system designers and architects to formally represent and validate a system.

There is often a time lag between designing and deploying a system. The lag is attributable to the time needed for systems integrators to manually instantiate required network components, provision and configure servers, install software, and configure applications. The integrator may additionally need time to harden or secure all servers and applications for security considerations. From the point of application design, the process usually requires days or weeks of time that can interrupt the design process.

Moreover, the system integrators manually performing the system deployment are usually not the original architects. As a consequence, there can be a loss of intent and message efficacy as interpreted by an integrator. Additionally, the process is fraught with human error because the configuration and security hardening of network components, servers, and applications is tedious.

As a result, most manually deployed, cloud-based solutions are non-compliant with the original design and fail to implement appropriate security controls. It can be difficult, time consuming, and expensive to identify failures. The correction of errors further adds delays (e.g., months) before a properly designed computer system can be deployed in virtualized environments, to include commercial Cloud Service Providers (CSP), private clouds, and virtual infrastructures supported by products such as VMWare, Hyper-V, Oracle VM, Xen, etc.

### SUMMARY OF THE INVENTION

The invention improves the use of computers as a tool by autonomously creating virtual computing systems in virtualized or cloud environments.

According to one embodiment of the present invention, a method of autonomously deploying a system component to a virtual environment includes designing a computer system product in a modeling language to generate a design model. The method may also include parsing the design model to generate a set of scripts comprising the virtual system components. The virtual system components may be deployed by executing the scripts.

According to another embodiment, an apparatus includes a memory storing program code and a design model, and a processor accessing the memory and executing the program code to design a computer system in a modeling language to generate the design model, parse the design model to generate a set of scripts comprising the virtual system components, and deploying the virtual system components by executing the scripts.

According to another embodiment, a computer product for assessing the state of a physical system, the computer product comprising a computer-readable storage medium having computer-readable program code embodied therewith, the computer-readable program code executable by one or more computer processors to design a computer system in a modeling language to generate a design model, parse the design model to generate a set of scripts comprising virtual system components, and deploying the virtual system components by executing the scripts.

### DRAWING DESCRIPTION

FIG. 1 is a block diagram of an embodiment of the invention for autonomously producing and deploying a product to a virtual environment.

FIG. 2 is a flow diagram of an embodiment of a method for autonomously deploying product components to a virtual environment.

FIG. 3 is another embodiment of a method according to the invention for autonomously deploying a product to a virtual environment.

FIG. 4 illustrates an example computing system according to an embodiment of the invention as realized in a networked environment.

FIG. 5 further illustrates a server, such as the server of FIG. 4, according to another embodiment of the invention.

### DESCRIPTION OF PREFERRED EMBODIMENTS

An embodiment of a system and method to autonomously deploy computer systems to virtual environments includes designing a product in a modeling language, such as Systems Modeling Language (SysML), Unified Modeling Language (UML), Business Process Model and Notation (BPMN), Service Oriented Modeling Framework (SOMF), or Integration Definition (IDEF). Associated processes may include persisting the system design model as a SysML, UML, BPMN, SOMF, or IDEF file. The system design model may be parsed to produce scripts for creating virtual system components. An embodiment of the method further leverages Application Programming Interfaces (APIs) to execute the system component creation scripts. Continuous Integration/Continuous Deployment (CI/CD) tooling may be used to secure, harden, and otherwise configure all system components. Servers may be scanned for security compliance. An embodiment of the method may further include validating that the deployed system is compliant with the system design model.

Embodiments of the method may improve both the timeliness and quality of a system deployment. The method facilitates the autonomous deployment of a computer system within minutes or hours. The automated processes help ensure that system components are properly configured and secured. The efficacy of the resultant system may be verified by using third-party tools and processes for testing, validation, and cybersecurity scanning.

The automated deployment method may enable deployment of a system during the design process to facilitate an iterative design cycle in a manner that promotes quality. Application architects may use an embodiment of the system to realize an iterative cycle of design, deploy, and destroy that allows validation of the system design in real time. The automated deployment method may allow designers and architects to immediately see results of their decisions and incrementally refine the system design.

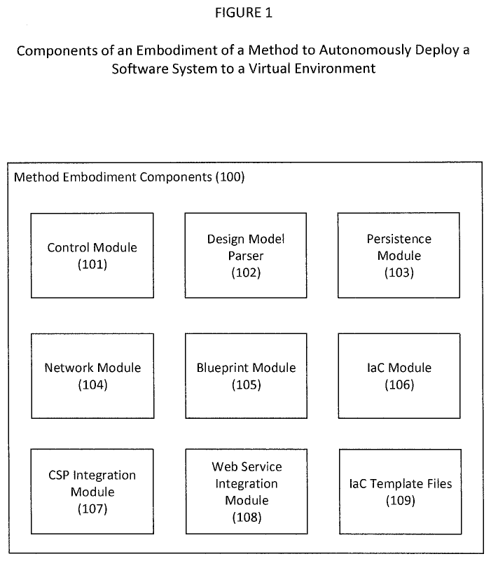

FIG. 1 is a block diagram of an embodiment of an apparatus, or system 100, which autonomously deploys a product in the form of a computer system to a virtualized environment. “Computer system” generally refers to any system that runs on a computing platform and may be comprised of network, server, and software application components. An illustrative virtual environment may include one or more commercial Cloud Service Providers (CSPs). The system 100 shown in the embodiment of FIG. 1 includes several components. A control module 101 may provide orchestration for the autonomous deployment and marshals all input and output communications. A parser 102 may accept and interpret a system design model of the computer system to be deployed. The design model of the computer system to be deployed may be persisted as a system modeling language file, such as SysML. The design model of the computer system to be deployed is referred to as the system design model. The parser 102 may parse the system design model and utilize the design as the driver for the computer system deployment.

All configuration settings and details may be encapsulated in the system design model. The configuration settings and details may be maintained in memory and used by the embodiment to autonomously build and deploy the resulting computer system.

A persistence module 103 may persist artifacts of the computer system deployment to either a file system or to a source code repository. The network module 104 may create a network configuration script based on the computer system design encapsulated in the design model. The network configuration script may be specifically tailored based on the target virtual environment and may be persisted by the persistence module 103.

The network configuration script may be sent to a network creation utility that uses it to materialize the computer system network components appropriate for the target Cloud Service Provider (CSP) or virtual environment. A blueprint module 105 may create an electronic representation of the computer system to be deployed. This electronic representation, or blueprint script, may be used to communicate the structure and configuration of the computer system to other software products that may be used to perform the autonomous system deployment.

The control module 101 may orchestrate communication with the other software products and provide the blueprint script as necessary to direct the deployment process. The blueprint script may be created by the blueprint module 105 and be persisted by the persistence module 103. The blueprint script of the blueprint module 105 may be executed by the control module 101 to manifest the computer system in the virtual environment.

An Infrastructure as Code (IaC) module 106 may create IaC script files. The IaC script files may be used to explicitly define the configuration of each component of the computer system being deployed. The CSP integration module 107 may manage the communication with the target CSP or virtual environment dependent upon the system design as specified in the system design model.

A web service integration module 108 may manage the electronic communications with the other software products used to perform the autonomous system deployment. The IaC template files 109 may include a local repository of template files that are maintained on the computer system. These template files are specific to different software applications that may be installed and configured as part of the deployed computer system. Each template file may provide the appropriate controls and settings necessary to properly install and configure an application such that it may operate as an integrated component of the deployed computer system. The template files may be used by the IaC module 106 to produce the IaC script files that are used to deploy the computer system

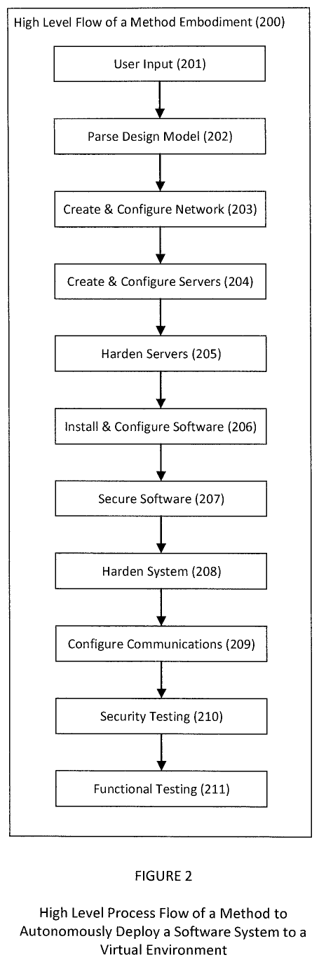

FIG. 2 is a high level flowchart of an embodiment of a method 200 to autonomously deploy computer systems to virtual environments. An embodiment of the method 200 may be performed by a system as exemplified in FIG. 1. The embodiment of the method 200 includes receiving a user input at 201. The user input may include either a system design model, or the location and credentials to access a system design model. The system design model may be a SysML, UML, BPMN, SOMF, or IDEF file.

The embodiment of the method 200 retrieves and parses the design model at 202. The system may use the specified architecture design to manifest the computer system in the CSP or virtual environment identified in the design. The method 200 may derive from the computer system architecture design the configuration details and parameters for the autonomously deployed computer system.

The embodiment of the method 200 may use the architecture design specified within the design model to create and configure at 203 any requisite environmental or network components within the target CSP or virtual environment. These environments may include components such as networks, sub-networks, gateways, security groups, firewalls, route tables, etc.

The method 200 may at 204 use the architecture design specified within the design model to create and configure the virtual servers within the target CSP or virtual environment. Creating and configuring servers includes either specifying or installing a computer server operating system.

The embodiment of a method 200 may modify the configuration settings of the computer system servers to harden them at 205 against cybersecurity attacks. The process and specific settings to be adjusted to secure the computer system servers may be dependent upon the operating systems and servers identified in the architecture design specified within the design model.

An embodiment of the method 200 at 206 installs and configures on the deployed and hardened virtual servers any computer applications identified in the architecture specified within the design model. The installed and configured applications may include either commercial software available from a distribution server or custom software maintained within a private source code repository. The embodiment of the method 200 may modify at 207 the configuration settings of the computer system application components to harden them against cybersecurity attacks. The process and specific settings to be adjusted to secure the system applications may be dependent upon the software components identified in the architecture design specified within the design model.

The embodiment of the method 200 may then at 208 harden the computer system as a whole by modifying the configuration settings of the computer system applications, servers, and network components to harden them against cybersecurity attacks. The process and specific settings to be adjusted to secure the aggregate computer system may be dependent upon the specific software, operating systems, servers, and network configuration identified in the architecture specified within the design model.

The embodiment of the method 200 at 209 configures electronic communications between the application, server, and network components of the deployed computer system. As part of hardening the computer system against cybersecurity threats, the embodiment of the method 200 may initially disable all communications into and out from the deployed computer system, as well as disabling all communications between system components. The embodiment of the method 200 may enable only the communication ports and protocols identified in the architecture design specified within the design model. If indicated in the design model, processes may also include the installation and application of industry standard identity certificates to facilitate the encryption of communications.

The method 200 at 209 may autonomously deploy the computer system to the target CSP or virtual environment. Prior to completion, the system may verify that the deployment was successful by validating the computer system.

Per the design specified within the design model, an embodiment of the method 200 performs security scans at 210 against the deployed computer system. The method 200 may further register the computer system with security monitoring utilities available within the target CSP or virtual environment. Results of the security scan may be captured and persisted as part of the autonomous deployment activity log.

Additionally, the embodiment of the method 200 may execute functional test scripts at 211 against the deployed computer system as indicated in the architecture specified within the design model. Results of the functional test scripts may be captured and persisted as part of the autonomous deployment activity log.

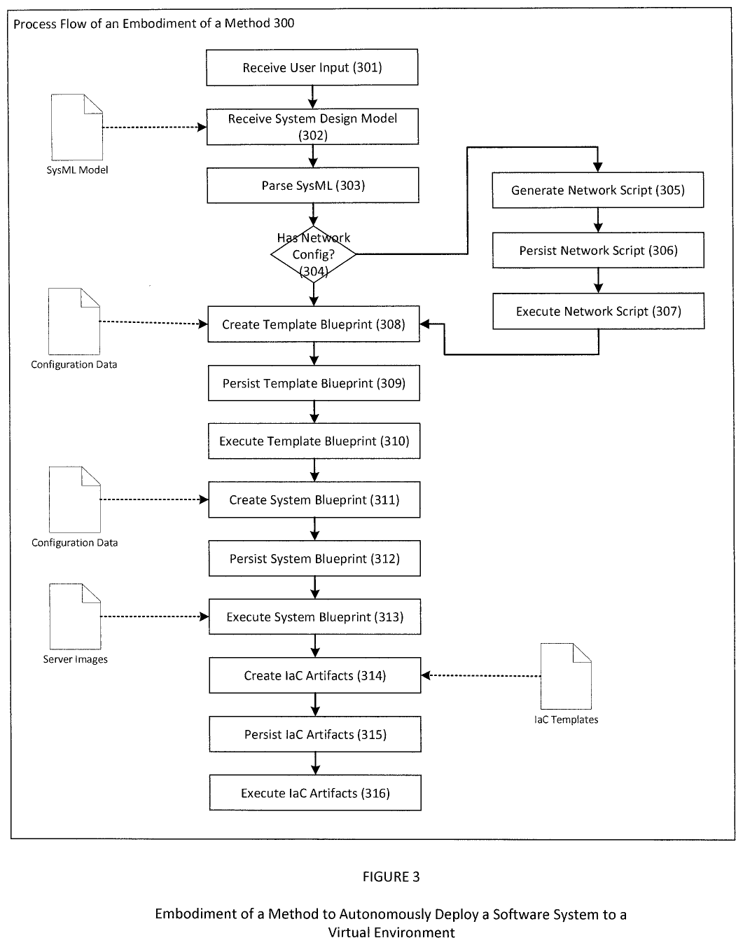

FIG. 3 represents another embodiment of a method 300 to autonomously deploy computer systems to virtual environments. According to the embodiment of the method 300, the system receives input from a user at 301 to autonomously execute the computer system deployment. The user input may include other items or information such as a file reference to the computer system design model, or user authorization credentials to access a source code repository. The computer system design model may be a SysML, UML, BPMN, SOMF, or IDEF file.

The system at 302 may access the computer system design model. The mechanism by which the method 300 accesses the design model may be based on where the model is persisted and the parameters provided by the user at 301. When the design model is accessed, the system at 303 may read it into memory and parse the model to capture all relevant parameters of the computer system to be autonomously deployed. Parsing the system design model, for example the SysML file, enables the method 300 to pull parameter values out of the model which specify attributes of the deployed system. Example parameter values may include, but are not limited to, component names, addresses, software to be installed, message ports and protocols, etc.

In an embodiment of the invention (FIG. 3), a control module, such as the control module 101 of FIG. 1, may utilize the Design Model Parser 102 to parse and interpret the system design to determine at decision 304 which aspects or components of a network need to be created and deployed as part of the computer system deployment. If network components do need to be manifested in the virtual environment, the control module at 305 may call the network module and generate a network creation and configuration script. The execution of a network creation and configuration script autonomously creates, provisions, and assembles product components according to the design model.

The network module may pass the network script to the persistence module. The persistence module may at 306 persist the script either to a file system or to a source code repository. Once the network script has been persisted, the network module at 307 may execute the network script by calling a network creation engine and passing the script to the engine. The network script may be executed by the embodiment of the method 300 using a CI/CD tool or a CSP API. Once the network has been created or modified and subsequently configured, the network module may pass execution back to the control module. The control module may call the blueprint module.

The blueprint module may query the design model and the network module to get specific information (e.g., configuration data) about both the computer system and the updated network components necessary to deploy and configure the computer system. The blueprint module may select product components and generate a template computer system blueprint file. The blueprint file created by the blueprint module may provide instructions about the instantiation of virtual computer systems to be deployed as part of the computer system.

The blueprint module may pass the template blueprint file to the persistence module that persists at 309 the template blueprint file either to a file system or to a source code repository. Once the template blueprint file has been persisted, the blueprint module may execute at 310 the template blueprint file by calling a virtual server creation engine and passing the template blueprint to the engine. The execution of 310 autonomously creates, provisions, and assembles product components according to the design model.

Once the template blueprint file has been executed, the blueprint module queries the virtual server creation engine to gain specific information necessary to finalize the computer system blueprint. The blueprint module uses this specific information to autonomously select product components and create at 311 a system blueprint that extends the original template blueprint and adds details that can only be ascertained once the template blueprint has been executed.

The blueprint module may pass the computer system blueprint file to the persistence module, which then persists at 312 the computer system blueprint file either to a file system or to a source code repository. Once the computer system blueprint file has been persisted, the blueprint module at 313 may execute the computer system blueprint file by calling a virtual server creation engine and passing the computer system blueprint to the engine. As part of the computer system blueprint execution, the virtual server creation engine may instantiate specific computer server images based on the computer system blueprint file. The execution of 313 autonomously creates, provisions, and assembles product components according to the design model.

Once the computer system blueprint file has been executed and all necessary servers have been created, the blueprint module may pass execution back to the control module, which then calls the IaC module. The IaC module of an embodiment of the system may query the design model, the network module, and the blueprint module to get specific information about the computer system, the new network components, and the new servers as useful to deploy and configure the computer system.

The IaC module may leverage a local collection of IaC template files and the information gathered from the design model, the network module, and the blueprint module to autonomously select product components and generate at 314 a set of IaC files specific to the computer system being autonomously deployed.

The IaC module may pass the created IaC files to the persistence module, which then persists at 315 the IaC files either to a file system or to a source code repository. Once the IaC files have been persisted, the IaC module may execute at 316 the IaC files by calling a collection of Continuous Integration/Continuous Deployment (CI/CD) tools and passing the IaC files to the tools. The CI/CD tools may install software components, modify software settings, and configure each component of the computer system as specified in the system design model. The execution of 316 autonomously creates, provisions, and assembles product components according to the design model. Once the computer system components have been configured, an embodiment of the method 300 has completed the autonomous deployment of the computer system to the virtual environment according to the architecture design specified within the system design model.

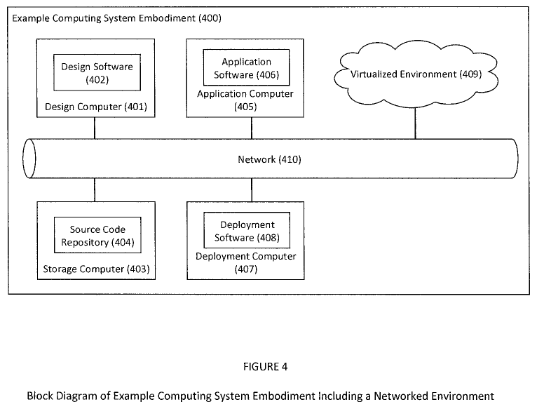

FIG. 4 illustrates an example computing system 400 according to one embodiment, such as may be realized using a networked environment. As shown, the computing system embodiment includes a design computer 401, a storage computer 403, an application computer 405, a deployment computer 407, and a virtualized environment 409 that is the target for the autonomous computer system deployment.

All five of the illustrative computing system modules may be connected via a network 410 that includes local network capabilities as well as the ability to communicate remotely via the network or internet to the virtualized environment 409. The design computer 401 contains design software 402 that includes system design and architectural modeling software capable of producing a design model. The system design model may be created as a SysML, UML, BPMN, SOMF, or IDEF file.

A computer system architect or system designer may use the design software 402 to produce a valid design model of the computer system to be autonomously deployed. The system designer may then persist the design model in the source code repository 404 that runs on the storage computer 401. The system designer may then access the application software 406 that is an instance of an embodiment of a method to autonomously deploy a computer system to a virtual environment, as depicted in FIGS. 1-3.

The application software 406 may run on an application computer 405 that provides local processing resources for an embodiment of a method to leverage during the autonomous deployment of the computer system. During the autonomous deployment process depicted in FIGS. 2 and 3, an embodiment of a method being performed by the application system 406 may access resources in the source code repository 404 and on the storage computer 403, to include the design model file. Additionally, an embodiment of the method being performed by the Application System 406 may leverage deployment software 408 resident on the deployment computer 407 to perform standard aspects of the autonomous deployment. All of the components of an embodiment of a method to autonomously deploy a computer system to a virtual environment, as illustrated in FIG. 1, may be resident within the application software 406 running on the application computer 405. These components may communicate with other network resources, such as the source code repository 404 and the deployment software 408 across the network 410. Likewise, the deployment software 408 may communicate with the virtualized environment 409 via the network 410.

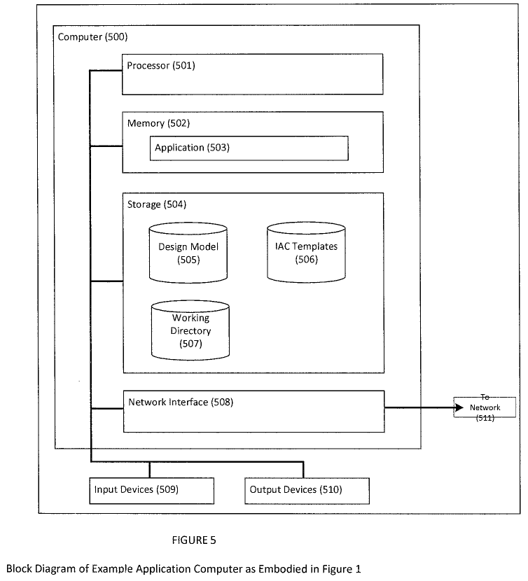

FIG. 5 further illustrates a computer 500, such as the application computer 405 of FIG. 4, according to one embodiment. The computer 500 generally includes a processor 501 connected via a bus to a memory 502, storage 504, a network interface device 508, input devices 509, and output devices 510. The computer 500 is generally under the control of an operating system. Examples of operating systems include the UNIX operating system, versions of the Microsoft Windows operating system, and distributions of the Linux operating system. More generally, any operating system supporting the functions disclosed herein may be used. The processor 501 is included to be representative of a single CPU, multiple CPUs, a single CPU having multiple processing cores, and the like.

Similarly, the memory 502 may be a random access memory. While the memory 502 is shown as a single identity, it should be understood that the memory 502 may comprise a plurality of modules, and that the memory 502 may exist at multiple levels, from high speed registers and caches to lower speed but larger DRAM chips. The network interface device 508 may be any type of network communications device allowing the computer 500 to communicate with other computers via the network 511.

The storage 504 may be a persistent storage device. Although the storage 504 is shown as a single unit, the storage 504 may be a combination of fixed and/or removable storage devices, such as fixed disc drives, solid state drives, removable memory cards, optical storage, and network storage systems.

As shown, the memory 502 contains the application 503, which may be an application generally executed to take actions described herein. Storage 504 contains the Design Model 505, IaC template files 506, and working directory 507. The system design model may be represented as a SysML, UML, BPMN, SOMF, or IDEF file. The input devices 509 may provide a keyboard and/or a mouse, etc. The output devices 510 may be any conventional display screen. Although shown separately from the input devices 509, the output devices 510 and input devices 509 may be combined. For example, a display screen with an integrated touch-screen may be used.

The descriptions of the various embodiments of the present invention have been presented for purposes of illustration, but are not intended to be exhaustive or limited to the embodiments disclosed. Many modifications and variations may be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “component”, “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Java, C++ or the like, general purpose programming languages (GPLs) such as Python, Ruby, JavaScript or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It may be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtual computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtual systems instantiated by the user). A user can access any of the resources that reside in the cloud at any time, and from anywhere across the Internet. In context of the present invention, a user may access applications (e.g., threshold adjustment algorithms) or related data available in the cloud. For example, the modules of FIG. 1 could execute on a computing system in the cloud and, in such a case, the threshold adjustment algorithms could adjust response thresholds and store the new values at a storage location in the cloud. Doing so allows a user to access this information from any computing system attached to a network connected to the cloud (e.g., the Internet).

In a practical application example, a user provides business process outsourcing to governments for the execution and maintenance of benefits programs. These benefits programs may include services such as Health Insurance Exchanges, Medicare/Medicaid, Unemployment, and Contact Tracing. The business process outsourcing may include enrollment, administration, management, business intelligence, or contact center services for the benefits programs. When the user wins a competitive bid to provide business process outsourcing to a new customer, or to provide new services for an existing customer, the company must establish a new computer infrastructure, install software, configure the software, secure the software, and then utilize these new computer systems to deliver services to the government customer.

Using the invention, a computer system designer creates a model of the computer system necessary to execute the project for the new customer. The computer system design model is created using SysML and comprises a network, an administration server, a database server running a commercial database (such as Oracle), a business intelligence server running a reporting software (such as Microstrategy), and an integration server running an ETL software (such as Pentaho). The system designer designates within the model that it is to be deployed within, for example, the AWS Cloud and provides the required data to provision and configure the network, servers, and software applications.

After the system design model is created, it is validated by the designer against system requirements. The validated system design model is then persisted in a Source Code Repository (SCR). The designer then executes the autonomous deployment method as described herein, and the method automatically processes the remaining steps to completion of the modified system in the virtualized environment. The method accepts the location of the system design model within the SCR along with appropriate credentials. The method then accesses the SCR, pulls the system design model as a SysML file, and parses the SysML file. A network creation script is created and persisted within the SCR. The network creation script is executed using a CI/CD tool, resulting in the network being created within the AWS Cloud.

More data is queried from the SysML file and from the newly created network to create a system blueprint file. The system blueprint file is persisted in the SCR and subsequently executed by CI/CD tools. After the blueprint file is executed, the four computer system servers designated in the system design model are provisioned and available in the AWS Cloud. Then the process queries the SysML, the network, and the blueprint file to create a set of configuration scripts to install the software applications. A configuration file is produced for the administration server which tells a CI/CD tool to configure the operating system by eliminating common administrative accounts, creating system specific accounts, establishing password rules, creating system users and groups, and assigning users to appropriate groups. The process creates a configuration file to install, for example, Oracle Database Manager on the database server, executes a SQL script to create a database in Oracle, executes another SQL script to populate the database with data, then configures Oracle to utilize the users and groups from the administration server. A configuration file is created to install, for example, Microstrategy on the business intelligence server, configure Microstrategy to connect to the Oracle database to access data for reporting, load a set of standard reports and dashboards in Microstrategy, and configure Microstrategy to utilize the users and groups from the administration server. The method will create a configuration file to Pentaho on the integration server, configure Pentaho to access a set of source systems for extraction of data, configure Pentaho to connect to the Oracle database to load data, load Pentaho with a set of transformation scripts to be executed during ETL processing, and configure Pentaho to run the transformation scripts every Monday through Friday at 4:45 am Eastern. All these configuration files are persisted in the SCR and then executed with the CI/CD tools. Once the configuration files are executed, the four servers previously provisioned in the network created within the AWS Cloud have their appropriate software installed and configured. Additionally, the required database has been created, data loaded, ETL jobs established, and all users and group assignments have been created. Once the computer system components are created, the method validates them by running functional tests or security scans that are indicated within the system design model.

Upon completion of execution, the system designer is able to access the computer system within the AWS Cloud. The method manifests actual changes to the data center computers within the AWS Cloud such that all the system components identified in the SysML model are properly provisioned and configured.

In another simple example, a computer system is designed that comprises a single cloud-based network, two servers, and a firewall. The computer system represents an operational product that provides an internet content management software which may be used to create an Internet marketplace according to the example. In one embodiment, the designed computer system is deployed to Amazon Web Services or Microsoft Azure.

In accordance with the invention specification, a design of the computer system (system design) is created. The system design is modeled in a modeling tool and persisted as a system design model. The system design model is persisted, for example, as a SysML, UML, BPMN, SOMF, or IDEF file. In the system design model, the two servers are contained within the network and the firewall controls network communications into and out of the network. In one embodiment, WordPress is installed on one of the servers and MariaDB, a database, is installed on the other server. The network and servers may be configured such that no network traffic is allowed within the network with the exception of HTTPS traffic over port 443 from outside the network to the WordPress server and secured SQL via SSL over port 1433 between WordPress and MariaDB. The firewall may be configured such that only HTTPS traffic over port 443 is transmitted across the network boundary between the internet and the WordPress server.

After the system design model is created, the system may be physically manifested as an operational product in a cloud service provider (CSP) such as Amazon Web Services or Microsoft Azure. Using the invention, the operational product is autonomously deployed to a virtualized environment within a CSP in accordance with the design documented in the system design model. The method of the invention accepts the system design model as input, autonomously selecting components according to the design model and autonomously creating, provisioning, and assembling the components as it parses the system design model. The method of the invention then creates and configures the network, servers, and firewall within the identified CSP. In this manner, the method of autonomously deploying a computer system to a virtualized environment physically manifests the desired product within the CSP to achieve a result heretofore accomplished by a deployment team or individual. Autonomous deployment according to the method creates a custom designed computer system in far less time than design and implementation by previously used methods that involve teams of people to create and implement the computer system design manually.

The method according to the invention may be replicated to autonomously deploy innumerable devices to create computer system products within virtualized environments. Further examples include benefits management systems for state Medicare/Medicaid agencies, commercial Command and Control systems aboard marine vessels, or point of sale and business intelligence systems to support retail franchises.

While the foregoing is directed to embodiments of the present invention, other and further embodiments of the invention may be devised without departing from the basic scope thereof.

What is claimed:

1. A method of designing and autonomously producing and deploying a product to a virtual environment, the method comprising the steps of:
designing a product in a modeling language to generate a design model;
producing the product in a virtualized environment by autonomously creating, provisioning, and assembling the product components according to the design model, wherein the product components comprise a virtual computer network, a virtual computer server, and a virtual computer software application; and,
configuring and deploying the product to a virtualized environment.

2. The method of claim 1, further comprising the step of using continuous integration/continuous deployment (CI/CD) tools to produce the product in the virtualized environment.

3. The method of claim 1, wherein the modeling language is selected from a group consisting of Systems Modeling Language (SysML), Unified Modeling Language (UML), Business Process Model and Notation (BPMN), Service Oriented Modeling Framework (SOMF), and Integration Definition (IDEF).

4. The method of claim 1, further comprising the step of persisting the design model prior to configuring and deploying the product components.

5. The method of claim 1, further comprising the step of persisting the provisioning, deployment, and configuration scripts prior to configuring and deploying the product components.

6. The method of claim 1, further comprising the step of validating that deployed product components are compliant with the design model.

7. The method of claim 1, wherein the step of generating the components comprises the step of creating system scripts that communicate product configuration data to a continuous integration/continuous deployment (CI/CD) tool.

8. The method of claim 7, further comprising the step of executing the system scripts to create the product in the virtualized environment.

9. The method of claim 1, further comprising the step of parsing the design model to generate the product components.

10. An apparatus for autonomously producing and deploying a product to a virtualized environment:
a memory storing program code and a design model file;
a processor accessing the memory and executing the program code to model a product in a modeling language to generate the design model, produce the product in a virtualized environment by autonomously creating, provisioning, and assembling the product components according to the design model, and configure and deploy the product to the virtualized environment.

11. The apparatus for autonomously producing and deploying a product to a virtualized environment of claim 10, wherein the product comprises a virtual computer network, a virtual computer server, and a virtual computer software application.

12. The apparatus for autonomously producing and deploying a product to a virtualized environment of claim 10, further comprising a continuous integration/continuous deployment (CI/CD) tool to configure the product.

13. The apparatus autonomously producing and deploying a product to a virtualized environment of claim 10, wherein the product is designed in a modeling language chosen from a group consisting of Systems Modeling Language (SysML), Unified Modeling Language (UML), Business Process Model and Notation (BPMN), Service Oriented Modeling Framework (SOMF), and Integration Definition (IDEF).

14. The apparatus for autonomously producing and deploying a product to a virtualized environment of claim 10, wherein the processor is further configured to validate that configured and deployed components of the product are compliant with the design model.

15. The apparatus for autonomously producing and deploying a product to a virtualized environment of claim 10, wherein the processor is further configured to parse the design model.

16. The apparatus for autonomously producing and deploying a product to a virtualized environment of claim 10, wherein the processor is further configured to create system scripts that communicate product configuration data to a continuous integration/continuous deployment (CI/CD) tool.

17. A product for assessing the state of a physical system, the product comprising:
a computer readable storage medium having computer readable program code embodied therewith, the computer readable program code executable by one or more computer processors to:
model the product in a modeling language to generate a design model;
access the memory and execute program code to model a product in a modeling language to generate the design model, produce the product in a virtualized environment by autonomously creating, provisioning, and assembling the product components to create the product according to the design model; and
configure and deploy the product to a virtualized environment.

18. The product for assessing the state of a physical system of claim 17, wherein the computer readable program code is further executable to validate that configured and deployed product components are compliant with the design model.

19. The product for assessing the state of a physical system of claim 17, wherein the product components comprise a virtual computer network, a virtual computer server, and a virtual computer software application.
